(19) United States
(12) Patent Application Publication
(10) Pub. No.: US 2018/0162066 A1
(43) Pub. Date: Jun. 14, 2018

(54) Determining an error in operation of an additive manufacturing device

(71) Applicant: CANON KABUSHIKI KAISHA, Tokyo (JP)

(72) Inventors: Christian Bruwer, Westmead (AU); David Karlov, Emu Plains (AU)

(21) Appl. No.: 15/375,000

(22) Filed: Dec. 9, 2016

(51) Int. Cl. B29C 67/00; B33Y 30/00; B33Y 50/00; G05B 19/4099; G05B 19/406

(52) U.S. Cl. CPC B29C 67/0088; B33Y 30/00; G05B 2219/49023; G05B 19/4099; G05B 19/406; B33Y 50/00

(57) ABSTRACT

A system method for determining an error in building a three-dimensional object by an additive manufacturing device. The method comprises receiving a vibration signal, the vibration signal representing vibration of a propagation medium caused by the additive manufacturing device building the three-dimensional object by depositing layers of a structural material under control of a sequence of synthesizing instructions and mapping a portion of the received vibration signal to at least one instruction from the sequence of synthesizing instructions to identify a portion of the received signal corresponding to deposition of the structural material, the mapping based on one or more features associated with the synthesizing instructions. The method also comprises analysing a spectral representation of the identified portion of the received signal based on at least one predetermined criterion to determine the error.

### TECHNICAL FIELD

The present invention relates generally to a system and method for determining an error in a 3D printing process. In particular, the present invention relates to a system and method for timely detection of failures during a 3D printing process.

### BACKGROUND

Typically, additive manufacturing, also referred to as 3D printing, is a slow process that takes many hours to complete. Larger print jobs may take days to complete. 3D printing still has a relatively high failure rate, especially when a design is printed for the first time and the design's printability is unproven. Most 3D printers do not have any in-built way to detect failures or errors during the printing process. The earlier a failure can be detected, the less time and material that is wasted.

Additive manufacturing or 3D printing builds an object by fusing layer upon layer iteratively of metal, synthetic, or other structural materials. Even with current state of the art systems additive manufacturing is often a slow process. Various parameters may be recorded and monitored when building an object. The recording and monitoring parameters may be integrated with the printer functionality or provided by 3^{rd} party functionality. In many cases the build parameters are logged but typically no action is taken when parameters drift outside of the norm, although the logs may be used to certify the quality of the object that was built. For example, if a drop in laser power is discovered in a log of a metal printing process this could be an indication that a layer within an object that was built had badly fused and the object manufactured could be in danger of delamination. Although information from the process parameters could be used for real time monitoring, this is not yet widely done. Typically, even state of the art printers do not use the monitored parameters to trigger corrective action during build time, resulting in wasted time and material as the built object would likely have to be discarded if such an error is detected in the print logs after completion.

Some 3D printing monitoring systems capture layer by layer images of an object being built. The captured images may be either optical and/or depth images of the object being built. Based on the image data it is possible to determine whether an error has occurred or is occurring in building the object. However there are a number of complications with using information from layer by layer images. For example, an extruding head of a 3D printer typically occludes the object from the view of the image capture device being used. In order to get a clear view, the extruding head has to be moved out of the way of the image capture device completely, which has an associated performance impact. Furthermore, the layers being added are in the micro-meter range, making immediate detection (either manually or automatically) of a faulty layer difficult. Such systems are further complicated by the fact that the material being printed is typically uniform in colour, and a single layer of difference is difficult to detect optically. A depth image may be used, however using a depth image requires equipment that is able to determine a highly accurate depth estimate, the cost of accurate depth estimate requirement for cheap fused filament fabrication processes is not worthwhile, and for expensive metal printers, must typically operate in a hostile environment. Other methods for the fused filament fabrication process monitor a rate of consumption of the filament. Monitoring the rate of consumption of the filament has a drawback of not knowing whether the filament is being fused correctly and is also only capable of detecting one type of error.

There is thus a need for an alternative system that can detect an error during the 3D printing process and alert a user to allow for taking either immediate corrective action or to abort the print, thereby allowing an error to be addressed when it occurs instead of hours or even days later.

### SUMMARY

It is an object of the present invention to substantially overcome, or at least ameliorate, at least one disadvantage of present arrangements.

One aspect of the present disclosure provides a method for determining an error in building a three-dimensional object by an additive manufacturing device, the method comprising: receiving a vibration signal, the vibration signal representing vibration of a propagation medium caused by the additive manufacturing device building the three-dimensional object by depositing layers of a structural material under control of a sequence of synthesizing instructions; mapping a portion of the received vibration signal to at least one instruction from the sequence of synthesizing instructions to identify a portion of the received signal corresponding to deposition of the structural material, the mapping based on one or more features associated with the synthesizing instructions; and analysing a spectral representation of the identified portion of the received signal based on at least one predetermined criterion to determine the error.

Another aspect of the present disclosure provides a method of determining an error in synthesising a three-dimensional object by a manufacturing device, the method comprising: receiving a vibration signal, the vibration signal recording vibration of a propagation medium caused by the manufacturing device synthesising the three-dimensional object under control of a sequence of synthesising instructions; mapping a portion of the received signal to at least one instruction from the sequence of synthesising instructions, the mapping based on features associated with the synthesising instructions; and analysing a spectral representation of the received signal based on the mapping to determine the error.

Another aspect of the present disclosure provides a method of determining an error in depositing layers of a three-dimensional object by an additive manufacturing device, the method comprising: operating the additive manufacturing device under control of a plurality of predetermined instructions; receiving a vibration signal, the vibration signal recording vibration of a propagation medium caused by the additive manufacturing device operating under control of the plurality of predetermined instructions; mapping a portion of the received vibration signal to at least one instruction from the plurality of predetermined instructions; analysing a spectral representation of the received vibration signal based on the mapping to determine features of the error occurring in depositing layers of a structural material; and determining occurrence of the error using the determined features.

In one aspect, mapping the portion of the received vibration signal comprises synchronising the received vibration signal with the synthesising instructions by the insertion of blocking non-synthesising instructions.

In one aspect, the predetermined instructions relate to one of depositing and non-depositing instructions and the mapping is used to train a classifier to identify depositing instructions.

In one aspect, mapping the portion of the received vibration signal comprises predicting a time taken by the synthesising instruction based on the synthesising instruction and a state of the additive manufacturing device.

In one aspect, the method further comprises training a classifier based upon vibration of the propagation medium during operation of the additive manufacturing device; and using the classifier to map the portion of the received signal to the at least one synthesising instruction.

In one aspect, the propagation medium relates to one of an atmosphere of a volume surrounding the additive manufacturing device or a frame of the additive manufacturing device.

In one aspect, mapping of the received signal to the at least one synthesising instruction is synchronised by detecting a layer transition of the additive manufacturing device.

In one aspect, analysing the spectral representation of the received vibration signal comprises determining a likelihood score by combining a plurality of frequency coefficients of the spectral representation, the plurality of frequency coefficients weighted in accordance with a set of weighting factors, wherein the weighting factors used to discriminate between a first set of frequencies associated with depositing of the structural material and a second set of frequencies associated with errors of depositing the structural material; and comparing the determined likelihood score with a predetermined threshold to detect the depositing error

In one aspect, determining the error comprises combining analysis of a plurality of contiguous portions of the received vibration signal.

In one aspect, structural material deposition of the additive manufacturing device is a fused filament fabrication process, and the determined error relates to an extruding failure.

In one aspect, structural material deposition of the additive manufacturing device is a powder bed melting or sintering process, and the determined error relates to a heat source or energy beam failure.

In one aspect, the vibration signal is an acoustic signal.

Another aspect of the present disclosure provides an apparatus for determining an error in synthesising a three-dimensional object by an additive manufacturing device, the apparatus comprising: a vibration sensor recording vibration of a propagation medium caused by the manufacturing device synthesising the three-dimensional object under control of a sequence of synthesising instructions; a monitoring module coupled with the vibration sensor, the monitoring module being configured to map a portion of the recorded vibration signal to at least one instruction from the sequence of synthesising instructions, the mapping based on features associated with the synthesising instructions; and a synthesising error detection module coupled with the vibration sensor and the monitoring module, the synthesising error detection module configured to analyse a spectral representation of the portion of the received signal based on the mapping to determine the error.

In one aspect, the vibration sensor is attached to the additive manufacturing device to detect vibrations of the additive manufacturing device.

In one aspect, the vibration sensor is a microphone

In one aspect, the monitoring module is coupled with a controller of the additive manufacturing device, the monitoring module is configured to receive the sequence of synthesising instructions and analyse the sequence of synthesising instructions to map the portion of the recorded vibration signal to at least one instruction of the sequence of synthesising instructions based on features associated with the recorded vibration signal.

In one aspect, the monitoring module is configured to modify the sequence of the synthesising instruction to map the portion of the recorded vibration signal to at least one instruction from the sequence of synthesising instructions.

Another aspect of the present disclosure provides a system, comprising: an additive manufacturing device configured to build a three-dimensional object by depositing layers of a structural material under control of a sequence of synthesizing instructions; a monitoring device, the monitoring device comprising a vibration sensor configured to sense vibration of a propagation medium during operation of the additive manufacturing device, a processor; and a memory, the memory storing instructions executable on the processor to: receive a vibration signal from the vibration sensor; map a portion of the received vibration signal to at least one instruction from the sequence of synthesizing instructions to identify a portion of the received signal corresponding to deposition of the structural material, the mapping based on one or more features associated with the synthesizing instructions; and analyse a spectral representation of the identified portion of the received signal based on at least one predetermined criterion to determine an error in building the three-dimensional object.

Another aspect of the present disclosure provides a computer readable medium having a program stored thereon for determining an error in building a three-dimensional object by an additive manufacturing device, the program comprising: code for receiving a vibration signal, the vibration signal representing vibration of a propagation medium caused by the additive manufacturing device building the three-dimensional object by depositing layers of a structural material under control of a sequence of synthesizing instructions; code for mapping a portion of the received vibration signal to at least one instruction from the sequence of synthesizing instructions to identify a portion of the received signal corresponding to deposition of the structural material, the mapping based on one or more features associated with the synthesizing instructions; and code for analysing a spectral representation of the identified portion of the received signal based on at least one predetermined criterion to determine the error.

### BRIEF DESCRIPTION OF THE DRAWINGS

One or more embodiments of the invention will now be described with reference to the following drawings, in which:

FIG. 1 is a schematic diagram of a system comprising a typical Fused Filament Fabrication 3D printer and configured to determine an error in operation of the 3D printer;

FIGS. 2A and 2B form a schematic block diagram of a general purpose computer system upon which arrangements described can be practiced;

FIG. 3 is a schematic flow diagram illustrating the method of creating two classifiers as used in the method of FIG. 6;

FIG. 4 is a schematic flow diagram illustrating a method of creating a classifier to determine a type of synthesizing instruction implemented by the 3D printer;

FIG. 5 is a schematic flow diagram illustrating a method of creating invention classifier to determine if a synthesizing error has occurred in the 3D printer implementing an error;

FIG. 6 is a schematic flow diagram illustrating a method of determining an error in building a three-dimensional object by a 3D printer; and

FIG. 7 is a schematic flow diagram illustrating a method of processing g-code instructions as used in the methods of FIG. 4 and FIG. 5.

### DETAILED DESCRIPTION INCLUDING BEST MODE

Additive manufacturing devices, also referred to as 3D printers, are used to synthesize or build three-dimensional objects from a structural material based upon a sequence control instructions. G-code, also referred to as RS-274, is a software language commonly used numerical control programming language for operating a typical fused filament fabrication 3D printer or another type of 3D printer such as a sintering printer. G-code is typically generated by Computer Aided Manufacturing (CAM) software. Typically, 3D printers include a CAM step in a printing pipeline. The CAM software converts a model, typically originating from CAD (Computer Aided Design) software to g-code instructions that manufacturing machines can execute in order to create the object in question. G-code instructions are also referred to as synthesizing instructions. For 3D printing, g-code follows the same structure as originally used for subtractive manufacturing machines, with some slight adaptations to cater for the different manufacturing processes and machine capabilities. The g-code language is relatively easily extensible and adaptable. Many manufacturers, including users of traditional subtractive manufacturing machines, have implemented slight variations of the g-code language that may be incompatible with each other as new commands are introduced to specify the use of capabilities that are unique to certain machines. The g-code instructions, also referred to as synthesising instructions, specify parameters that a machine will implement during a manufacturing cycle. Examples of parameters specified by g-code include a path the extruding head must follow, a speed of movement, a movement of the build platform, and a rate at which material is to be deposited in the case of additive manufacturing machines. In the case of subtractive manufacturing machines, parameters specified by g-code include a route and rotational speed of a cutting tool, and the like.

Furthermore for 3D printers, a g-code file typically contains instructions for the switching on and off of cooling fans and a speed the cooling fans should run at. An extruder temperature is also typically specified in g-code, and often needs to be changed according to the material being used for manufacturing. For example, the extruding head temperature used for extruding PLA plastics is 190° C.-230° C. which is lower compared to using ABS plastics (requiring temperatures somewhere between 260° C. and 285° C.). ABS plastics would not melt if using the temperature settings suitable for PLA plastics. However, differences exist between machine manufacturers, where some of these commands may not automatically be present in the g-code file sent to a device by a driver, but would instead be automatically inserted at the beginning and end of the print cycle by the printer controller in order to allow a user to change the print material as a setting on the printer, independently of the g-code file.

Some recent manufacturing processes make use of hybrid processes where an object is iteratively built up using an additive process that overbuilds, and is subsequently machined back, by a small amount as layers are being added. Use of hybrid processes has an advantage of not wasting as much material as traditional subtractive processes do when machining from a solid block, and achieves the much higher accuracy of subtractive processes than what is currently achievable by purely additive processes. Hybrid processes are also controlled by g-code.

The problem of real-time monitoring building or printing of an object is addressed herein by analysing the sound emitted during the printing process. The sound is sensed or recorded by a monitoring device. In order to detect whether an error is occurring during the 3D printing process, the monitoring device needs to be able to distinguish between mechanical sounds the printer makes that do not result in material being added to the object being built, and sounds that do contribute material being added to the object being built. The monitoring device is also required to identify sounds that should be adding material to the object being built, but are not. For example, when a nozzle of the extruding head is clogged, the extruding head goes through all the motions that would be expected to go through when depositing material, but no material is being laid down. Machine learning techniques are used to train classifiers that can distinguish all such sounds, even though to a human observer there may be no detectable audio differences. Using acoustic (audio samples) or vibration signals for monitoring the build has a benefit that the print can be monitored, either by a controller of the 3D printer or by a separate monitoring device. Further, using acoustic or vibration signals for monitoring the build is not processor intensive, and avoids processing and issues described above with regard to using visual monitoring. Additionally, hardware involved for detecting or recording vibration signals for monitoring the build is typically low-cost.

Spectral analysis of audio or vibration signals described herein is based on a logarithm of the Fast Fourier Transform (FFT) components for a 200 ms window of recorded audio or vibration samples (sampled at for example 48 kHz thereby capturing the audible spectrum) as input. The logarithm of frequency components are also referred to as an audio window in the description below. In some arrangements, some frequencies of the recorded signal are discarded when determining the logarithm of the frequency components. For example, frequency components unlikely to be related to operation (whether correct or in error) of the 3D printer, or frequencies outside a range of a vibration sensor monitoring the build, may be discarded.

In a typical arrangement described herein, two classifiers are trained. A first one of the classifiers classifies an audio window as being associated with printing or non-printing actions. Printing actions are any actions associated with g-code specifying that material is to be added to a layer. Printing actions are also referred to as depositing instructions. Non-printing actions are, for example, movement of the build platform, or extruding head movements for a purpose other than building part of a layer. Non-printing actions are also referred to as non-depositing instructions. Once the first classifier can distinguish between non-depositing and depositing actions, the second classifier is trained. The second classifier is trained to classify any audio window classified by the first classifier as a depositing action, as either a successful or an unsuccessful depositing action.

The frequency components of the 200 ms audio windows are used as features for both the training of logistic regression classifiers, and are subsequently classified by the trained logistic regression classifiers. Logistic regression is an example of a simple and low-cost machine learning algorithm. A training process for the logistic regression algorithm determines a number of weighting factors for the frequency components. Each frequency component and an initial offset weight forms a logistic regression training feature, where each weighting factor effectively determines the relative importance of the associated frequency component. The weighting factors, together with the frequency components in an audio window, are applied to determine a likelihood score between 0 and 1. The score is used to determine how an audio window is classified. For example, an audio window may be classified as depositing or non-depositing, and subsequently, if depositing, whether successful or non-successful.

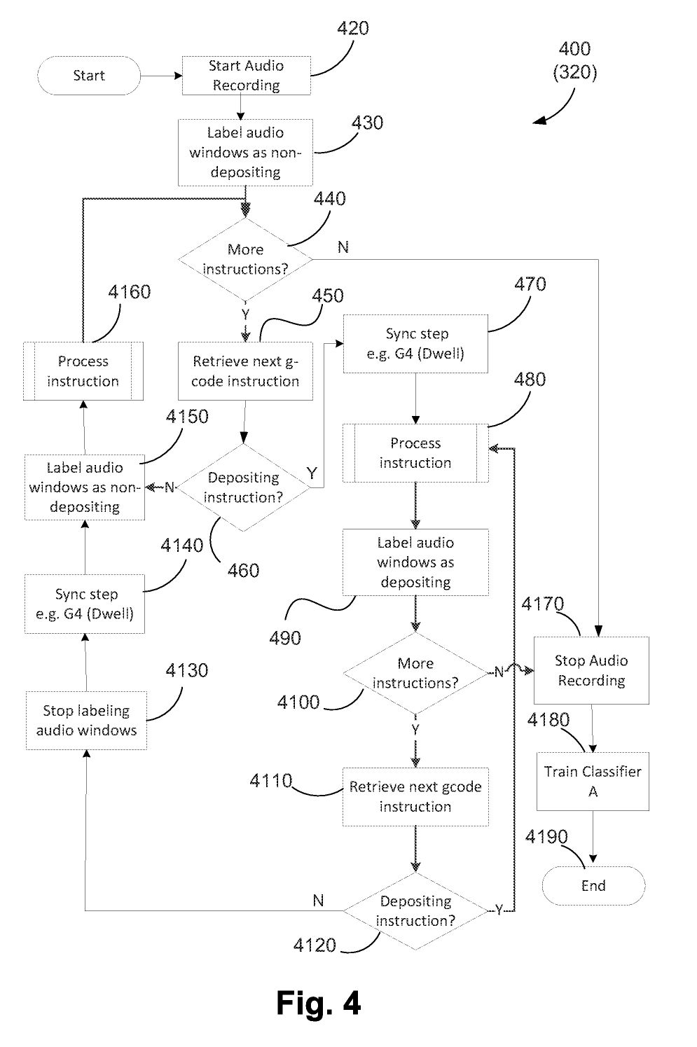

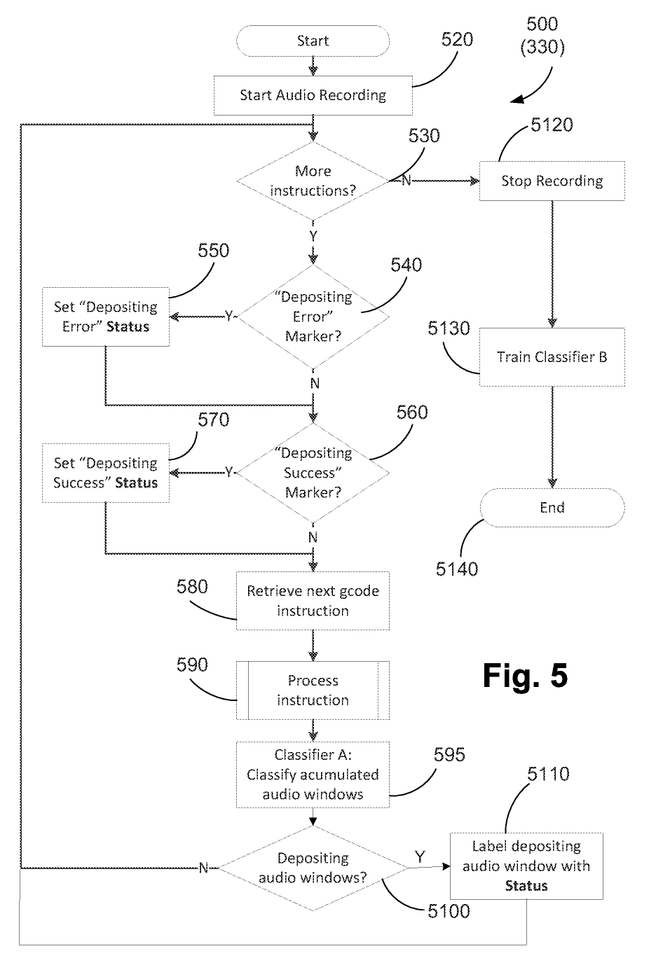

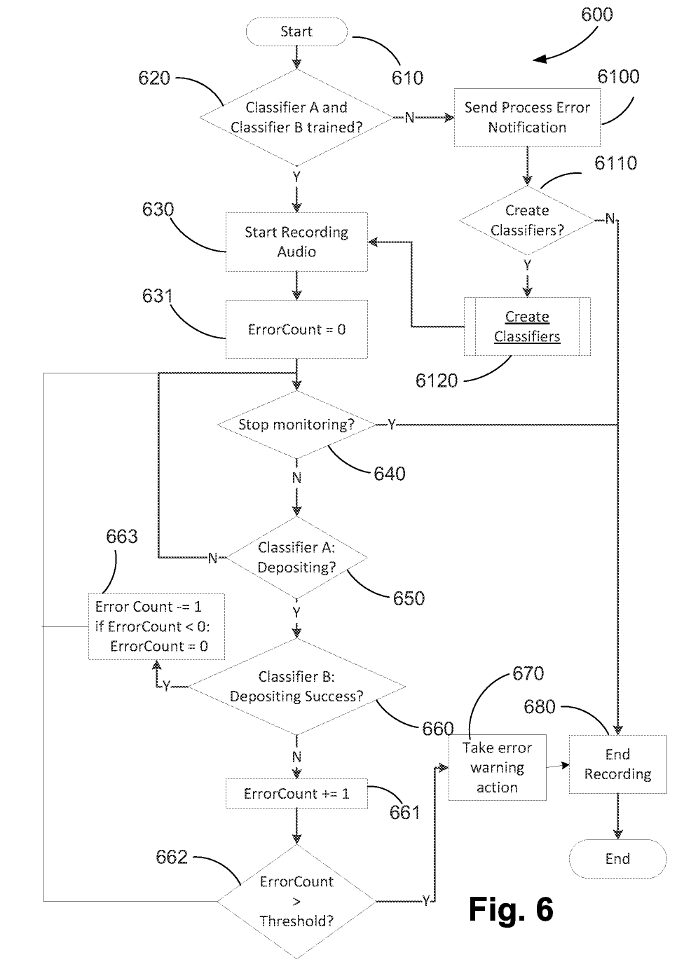

One set of weighting factors is determined in training the classifier A. The weighting factors for classifier A to distinguish or discriminate frequencies associated with a type of instructions (such as instructions for depositing structural material) are determined at step 4180 of FIG. 4. Another set of weighting factors is determined in training the classifier B to discriminate frequencies associated with a successful instructions (for example a non-erroneous implementation of a depositing) instructions at step 5130 of FIG. 5. The likelihood score is determined in training the classifiers at step 4180 and 5130, to be described. The respective likelihood score is associated with an audio window corresponding to a vibration signal at each of steps 650 and 660 of FIG. 6, described below.

A threshold, in some implementations a predetermined threshold, is used in classifying objects using the likelihood score. The threshold used for the likelihood score is typically 0.5, but the threshold is a parameter that can be adjusted depending on user need. For example, if a likelihood of 1 indicates a depositing instruction while a likelihood of 0 indicates a non-depositing instruction, the threshold can be lowered to 0.25 to reduce the likelihood of wrongly classifying a depositing audio window as non-depositing, with a trade-off of getting more false negatives for depositing audio windows.

An alternative to using the logistic regression algorithm as a classifier is use of a support vector machine (SVM) algorithm. Alternatively, if significantly increased accuracy is required a more complex machine learning algorithm such as a deep neural network can be used to replace the logistic regression algorithm (the logistic regression algorithm performs adequately for this application). The robustness of the system is improved by only triggering a decision on failure if a number of audio windows are classified as a failure within a short time period.

In order to train the classifier, the classifier needs to learn which sounds are attributed to which causes. The system 100 described is able to work for many different printer types that are used in different configurations and within different environmental conditions, and each monitoring device is trained for each 3D printer separately. In order for the learning to be practical the learning is an automated process. As previously described, 3D models are typically transformed for printing to g-code, containing the instructions that specify the actions and movements that the printer should implement. Knowing which g-code instructions are in the process of being executed allows a training system to label audio data exactly according to what the printer is doing at any given point.

To train both classifiers, the printer prints a test model for which the audio windows are labelled appropriately according to the g-code being processed by the printer. The test model used for training is chosen such that the corresponding g-code representation specifies common movements which would be typically used by the printer, the movements effectively being various length straight line extrusions, and are extrusions of various radiuses and lengths and at typical speeds. The variation in straight and are movements also have to be taken into account specifically for the first layer on the build plate which is often problematic and a frequent stage at which errors occur. In order to be able to discriminate between good and bad printing cases, the g-code is used without amendment to teach the first classifier to be able to distinguish between printing sounds and non-printing sounds. When the first classifier has been trained, the test model is printed again. When printing the test model again, every audio window that is classified (by the now trained first classifier) as a printing action, is labelled as successful. Subsequently the model is printed a number of times again, with the print being effectively caused to fail in various ways by inserting certain g-code commands which will cause the failures. For example, g-code is inserted at the beginning of the file which partially retracts the filament with the remaining g-code for the test model subsequently being sent without change. Resultantly, the extruding head goes through all the movements the extruding head usually would when printing, but without depositing material (which has not yet reached the extruding head again). All audio windows classified as depositing actions by the first classifier are marked as unsuccessful. The process is repeated again, with the model being printed again, but this time with g-code inserted at the beginning of the file that drops the extruder temperature below the melting point of the building material, thereby causing a clogged nozzle. Again, all audio windows classified as depositing actions by the first classifier are marked as unsuccessful. The successful and unsuccessful audio windows are used to train the second classifier. In order to verify that the printing process did not unintentionally fail during the training process, a user of the system 100 compares the models that were built during the training with a specified reference output of the models that are expected to be created during this process.

Once the classifiers have been trained, the classifiers can be used for monitoring a 3D printing process. In the configuration described, when the first classifier recognizes g-code being executed associated with building actions, the audio window is passed to the second classifier to verify whether the building action was successful or not. As false positives (where a positive in this case refers to an error occurring) can occur, the monitoring system typically does not alert the user immediately with the first classified failure. If a number of failures are detected in short succession, an alarm is raised, and if connected with the 3D printer controller, can pause the 3D printing process immediately.

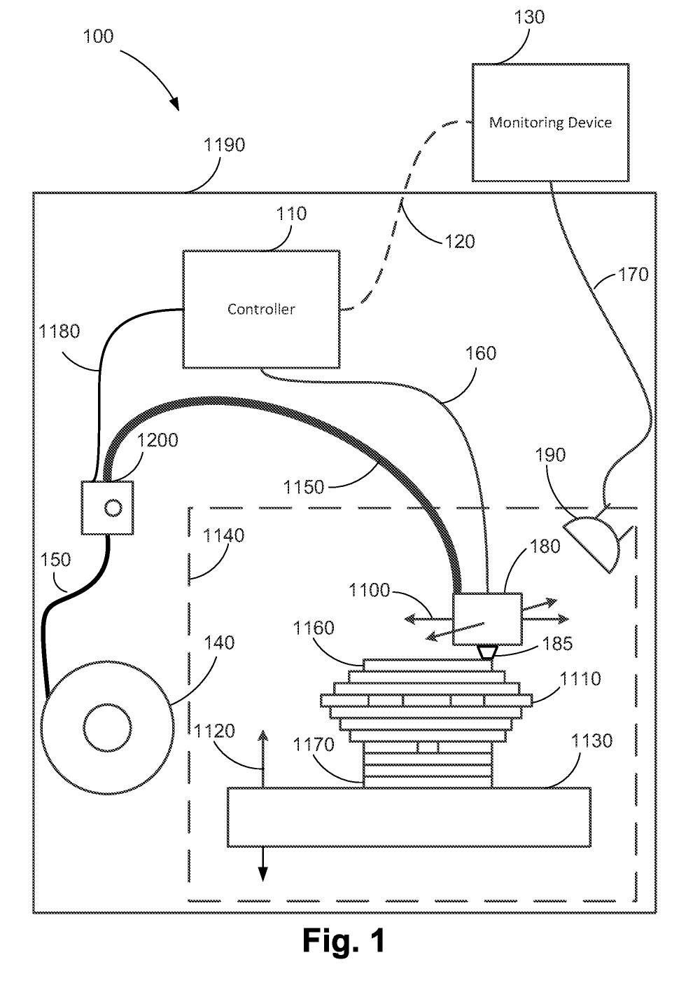

A 3D printing system 100 is depicted in FIG. 1. A controller 110 for a 3D printer 1190, also referred to as an additive manufacturing device, controls movement of an extruding head 180 to which the controller 110 is connected by control line 160. A heated nozzle 185, also controlled by the controller 110, deposits structural material consisting of a molten filament 150 and adds the deposited material to an object 1110 being built (also referred to as being synthesized). The filament 150 is stored on a spool 140 and guided to the extruding head 180 within a flexible tube 1150 using a mechanical feeder 1200. The mechanical feeder 1200 is controlled by the controller 110 using a control line 1180. The extruding head 180 can move in any direction indicated by an axis system within a horizontal plane.

A build platform 1130 moves up and down as indicated along an axis 1120. When starting building the object 1110, the empty build platform 1130 moves up to just below the nozzle 185 at which point the extruding head 180 starts laying down a first layer 1170. A height of the object 1110 is built up as the build platform is lowered by the controller 110 for each new layer. A newest layer 1160 is always added at the top of the object 1110. A build volume 1140 may be enclosed, in order to filter fine particles emitted by the melting of the plastic, and for better environmental temperature control.

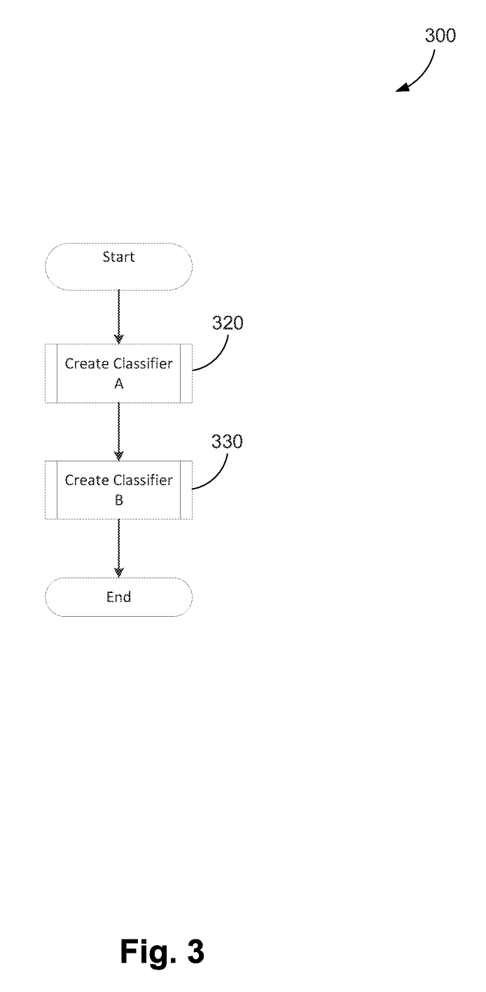

A vibration sensor 190, in the example of FIG. 1 a microphone, is connected to a monitoring device 130 by a cable 170. The microphone 190 provides an embodiment of a vibration sensor 190. The vibration sensor 190 can be any type of sensor suitable for detecting sounds or vibrations generated by operation of the printer 1190. For example, in other arrangements the vibration sensor 190 is a sensor such as an ICP (Integrated Circuit Piezoelectric) sensor which must be attached to a main structural frame of the printer 1190. The ICP sensor used is typically specified for a similar frequency range as the audio spectrum discussed to allow use as a drop-in replacement. In arrangements using the ICP sensor the classifiers will require retraining as the frequency response is different. The monitoring device 130 is trained to detect printing problems for the specific printer 1190 which the device 130 is connected to, and within the particular environment of the printer 1190. The monitoring device 130 is trained according to a method 300, to be described in relation to FIG. 3. The monitoring device 130 is connected to the controller 110 via a USB cable 120 over which g-code commands are sent. When monitoring a 3D print, the monitoring device 130 does not require the USB cable 120 connection in some arrangements.

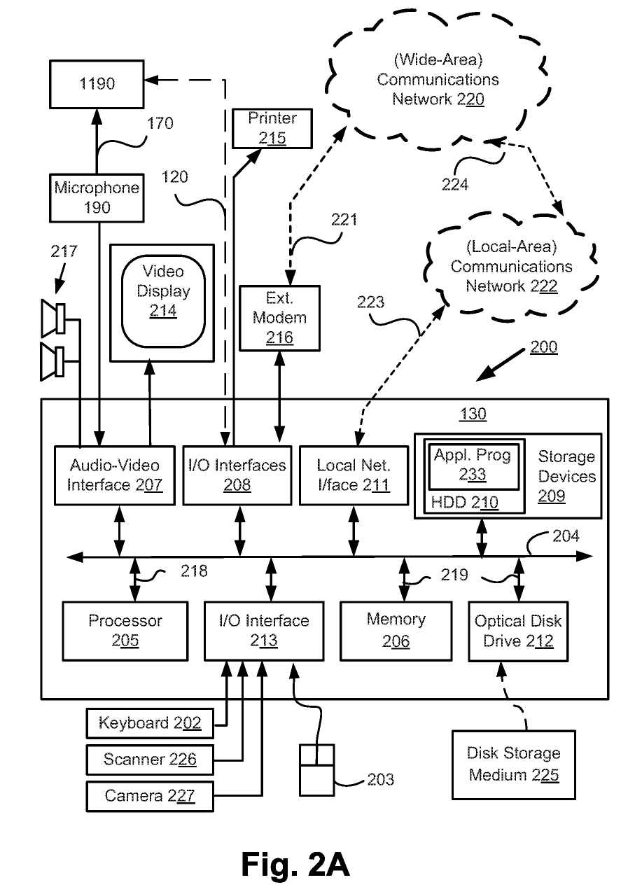

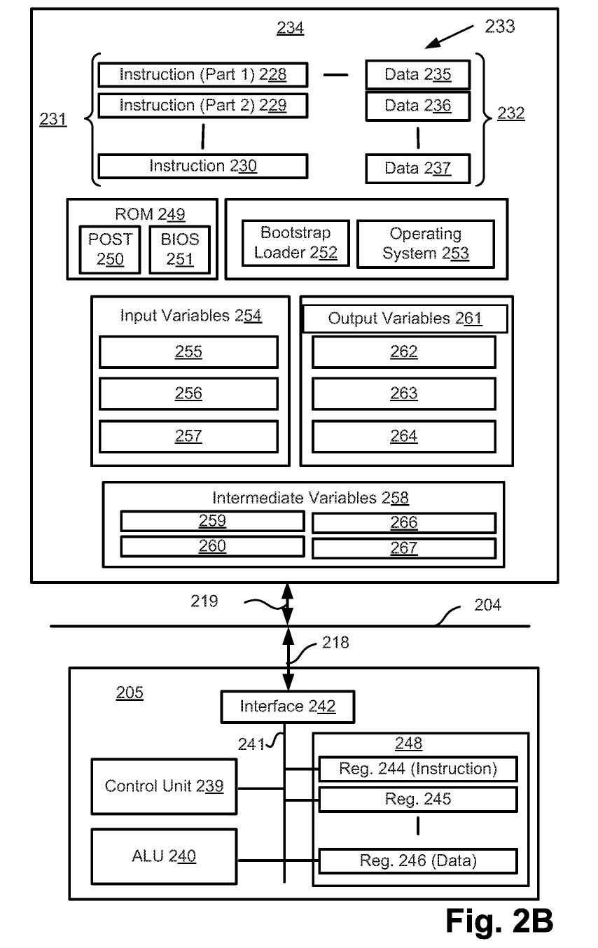

FIGS. 2A and 2B depict a general-purpose computer system 200, upon which the various arrangements described can be practiced.

As seen in FIG. 2A, the computer system 200 includes: a computer module being the monitoring device 130; input devices such as a keyboard 202, a mouse pointer device 203, a scanner 226, a camera 227, and the microphone 190; and output devices including a printer 215, a display device 214 and loudspeakers 217. An external Modulator-Demodulator (Modem) transceiver device 216 may be used by the computer module 130 for communicating to and from a communications network 220 via a connection 221. The communications network 220 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220.

In the arrangements described, the computer module 130 may be any general purpose computing device computing device which can be configured for communication with the controller 101. For example, the computer module 130 may be a server computer, a desktop computer, a laptop computer, a personal electronics device or the like. In other arrangements, the computer module (monitoring device) 130 can be a device with limited processing power, such as a tablet, a smartphone, or the like. Communication between the module 130 and the additive manufacturing device may be wireless, such as via a network, discussed below, or a wired connection such as the USB connection 120. In other arrangements, the monitoring device 130 may be integral to the 3D printer 1190.

The monitoring device 130 typically includes at least one processor unit 205, and a memory unit 206. For example, the memory unit 206 may have semiconductor random access memory (RAM) and semiconductor read only memory (ROM). The computer module 130 also includes an number of input/output (I/O) interfaces including: an audio-video interface 207 that couples to the video display 214, loudspeakers 217 and microphone 190; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 130, for example within the interface 208. The computer module 130 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 200.

The components 205 to 213 of the computer module 130 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparestations, Apple Mac™ or like computer systems.

The method of detecting an error in operation of an additive manufacturing device may be implemented using the computer system 200 wherein the processes of FIGS. 3 to 7, to be described, may be implemented as one or more software application programs 233 executable within the computer system 200. In particular, the steps of the method of FIGS. 3 to 7 are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the described methods.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212. A computer readable medium having such software or computer program recorded on it is a computer program product. The use of the computer program product in the computer system 200 preferably effects an apparatus for implementing the described methods.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 130. Examples of transitory or non-tangible computer readable transmission media that may also participate in the provision of software, application programs, instructions and/or data to the computer module 130 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217.

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 130 in FIG. 2A.

When the computer module 130 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 130 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 130 has sufficient memory in which to execute without colliding with memory allocated to another process. Furthermore, the different types of memory available in the system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The described arrangements use input variables 254, which are stored in the memory 234 in corresponding memory locations 255, 256, 257. The described arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

a fetch operation, which fetches or reads an instruction 231 from a memory location 228, 229, 230;

a decode operation in which the control unit 239 determines which instruction has been fetched; and

an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 3 to 7 is associated with one or more segments of the program 233 and is performed by the register section 244, 245, 247, the ALU 240, and the control unit 239 in the processor 205 working together to perform the fetch, decode, and execute cycles for every instruction in the instruction set for the noted segments of the program 233.

The methods described may alternatively be implemented in dedicated hardware such as one or more integrated circuits performing the functions or sub functions of one of FIGS. 3 to 7. Such dedicated hardware may include graphic processors, digital signal processors, or one or more microprocessors and associated memories.

FIG. 3 depicts a method 300 for creating classifiers for the purpose of training monitoring device 130 to detect problems with the printer 1190. The method 300 is typically implemented as one or more modules of the software application 233, controlled by execution of the processor 205 and stored in the memory 206.

Two classifiers are created in execution of the method 300. The role of the first classifier, classifier A, is to be able to identify printing sounds from non-printing sounds. The role of the second classifier, classifier B, is to be able to tell whether the printing sounds identified by classifier A are successful. The software 233 in some arrangements comprises a monitoring module for creating Classifier A and a synthesizing error detection module for creating Classifier B.

The first step of the method 3300 is execution of a sub-process at a creating step 320 to create classifier A. A method of creating classifier A is described in detail for a method 400 in relation to FIG. 4. The method 300 then progresses under execution of the processor 205 to a second step 330 of calling a method to create the classifier B. The method to create classifier B is described in detail in relation to FIG. 5 for a method 500.

FIG. 4 describes the method 400 of creating classifier A. The method 400 is typically implemented as one or more modules of the software application 233, controlled by execution of the processor 205 and stored in the memory 206. The method 400 relates to using predetermined g-code instructions to train the Classifier A to identify vibrations relating to a type of the g-code instruction. FIG. 400 is described in relation to determining implementation of a depositing g-code instruction.

The method 400 starts at a recording step 420. Audio or vibration recording is started in execution of the step 420. Operation of the additive manufacturing device 1190 generates vibration through a propagation medium associated with the additive manufacturing device 1190. For example, the propagation medium may relate to atmosphere of the volume 1140, or a frame of the device 1190. The step 420 relates to the vibration sensor 190 starting to record a vibration signal and transmit the recorded signal to the computer module 130. The monitoring device 130 receives the vibration signal in near real-time. Frequency components for audio samples accumulated every 200 ms are determined by operation of the processor 205 using a FFT (Fast Fourier Transform) and the logarithm of the magnitude is recorded (for example in the memory 206). The frequency components calculated using a Fast Fourier Transform for a 200 ms period are collectively referred to as an audio window in the following description. The recording and conversion to frequency domain at step 420 is performed continuously throughout the execution of the method 400.

The method 400 progresses under execution of the processor 205 from step 420 to a labelling step 430. At step 430, a global flag is set to mark or label the next audio windows as non-depositing. Non-depositing audio windows are audio windows in which captured sounds or vibration made by operation of the 3D printer 1190 (and the background environment) are not depositing sounds, e.g. movement of the build platform 1130. Depositing sounds (such as described in relation to step 490) are captured sounds made by the printer while the printer is executing g-code instructions whose normal result is material being extruded from nozzle 185 and added to layer of an object such as the layer 1160. While the global flag is set to “non-depositing”, all audio windows recorded by microphone 190 are labelled as non-depositing.

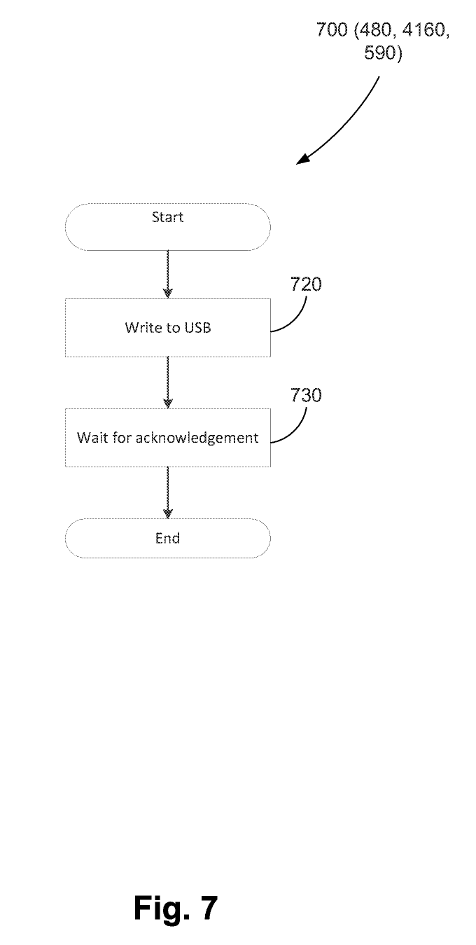

The method 400 progresses under execution of the processor 205 from step 430 to decision step 440. The step 440 forms an entry point and an exit condition for a main loop of method 400. The main loop of the method 400 starts at step 440. In creating the classifier A, the method 400 executing on the monitoring device 130 reads a complete g-code file and sends the g-code file line by line (with possible additional commands inserted, as will be explained for example for step 470) to the 3D printer 1190. Each process instruction call, such as called in steps 480 and 4160, and to a method 700 (FIG. 7) sends one line from the g-code file, i.e. one g-code instruction. The additive manufacturing device 1190 operates to implement the line of g-code. Step 440 determines whether a g-code file has been processed in entirety or not. If more g-code instructions need to be processed (“Y” at step 440), method 400 progresses under execution of the processor 205 from decision step 440 to a retrieving step 450.

The step 450 retrieves the next g-code instruction to be executed. If execution of step 450 is a first time the loop is executed, the next g-code instruction will be the first instruction of the g-code file. From step 450 the method 400 progresses under execution of the processor 205 to a decision step 460. Execution of the step 460 determines whether the g-code represents a depositing instruction. For many typical g-code variations, codes G0 (Rapid linear Move), G1 (Linear move), G2 (Controlled Arc Move—Clockwise) and G3 (Controlled Arc Move—Counter-Clockwise) represent depositing instructions if an E (length to extrude) field indicates a positive amount to be extruded. Determining a depositing instruction requires tracking comparison with previous instructions, as the amount to be extruded is typically a cumulative value).

If decision step 460 identifies the next g-code instruction to be executed as a depositing instruction (“Y” at step 460), the method 400 progresses under execution of the processor 205 to a synchronising step 470. In step 470, a g-code instruction is inserted that ensures the g-code instruction cache is empty. Every g-code instruction sent to a numerical control machine, like the 3D printer 1190, returns an acknowledgement. The 3D printer 1190 typically has a cache for g-code instructions many g-code instructions return an acknowledgement immediately (including depositing g-code instructions), while placing the instruction into a cache. Some g-code instructions however only return after the instructions have been executed, and the G4 dwell instruction is one such instruction. The G4 g-code instruction (a non-depositing instruction) inserts a pause of a specified length using a P parameter, which can be chosen to be zero in this application. The G4 instruction or command accordingly relates to a blocking non-synthesising instruction. Step 470 therefore inserts a g-code instruction within the g-code file as the instructions are sent line by line to the 3D printer 1190. The additive manufacturing device 1190 effectively receives a modified version of the g-code file including the inserted G4 code-instruction.

Having ensured that the g-code instruction is empty, the method 400 progresses under execution of the processor 205 to a processing step, 480. Execution of the step 480 sends the g-code to the 3D printer 1190 to be executed immediately. Resultantly, by the time the method 400 reaches step 490 the printer 1190 will have started executing the depositing instructions with the result that the audio windows will now be correctly labelled as depositing. The audio windows may not have been correctly labelled as depositing if the cache had not been empty and the additive manufacturing device 1190 had still been busy executing non-depositing instructions in the cache.

An excess of dwell instructions may slow down the printing operation. Alternative methods exist to synchronise g-code instructions and audio in step 470 to avoid this problem. Some implementations perform a pre-calculation or predicting step of building a mapping from g-code instructions to the time taken to perform the instructions. The mapping depends not only on the g-code instructions but on a state of the additive manufacturing device 1190 to determine a time taken to execute the instruction. For example, a movement command to an absolute position takes less time if the device's current position is closer to the target position. The mapping can be produced by preparing individual g-code instructions and machine states, and building up a database of predicted g-code processing durations. The direct mapping may drift over time due to inaccuracies. Drift can be countered by re-synchronising using dwell commands at key frame events such as an instruction to lower the build plate 1130 for fabrication of the next layer of the object 1110. An instruction to lower the build plate can also be referred to as occurrence of a layer transition.

An alternative implementation for synchronising g-code instructions and audio windows is to train a classifier for a purpose of recognising an audio signature of specific g-code instructions. Training to recognise audio signatures is aided by knowledge of the sequence of g-code instructions being performed, in a similar way to auto-dubbing technology which maps text to words spoken in an audio recording is aided by knowledge of the transcript of what was spoken. The methods for synchronising g-code instructions and audio windows described above may be used separately or in combination.

After synchronising g-code instructions and audio with step 470, the method 400 proceeds under execution of the processor 205 to a processing step 480. A method 700 of FIG. 7 is performed to process the instruction to send the depositing g-code instruction to the 3D printer 1190, as implemented at step 480. After sending the depositing g-code instruction to the 3D printer in step 480, the method 400 progresses to a labelling step 490. In execution of the step 490, the global flag for labelling audio windows is set to label all audio windows as depositing. Operation of step 490 operates to map a portion of the vibration signal received from the sensor 190 to one of the predetermined g-code instructions based on one or more features associated with the synthesizing instructions. In relation to mapping the vibration signal, relevant features of the synthesizing instruction typically relate to the instructions being extruding or depositing instructions. If the printer 1190 is a sintering device, the features of the instruction typically relate to being a heating or non-heating instruction. From step 490 the method 400 proceeds under execution of the processor 205 to a decision step 4100.

Step 4100 determines whether a g-code file has been processed in entirety or not. If there are more g-code instructions to be processed (“Y” at step 4100), method 400 progresses under execution of the processor 205 from decision step 4100 to a retrieving step 4110. Step 4110 retrieves the next g-code instruction to be executed. Next, the method 400 progresses under execution of the processor 205 from step 4110 to a decision step 4120. In decision step 4120, if the g-code instruction is a depositing instruction (“Y” at step 4120), method 400 loops back to step 480.

If, at decision step 4120, the g-code instruction is not a depositing instruction (“N” at step 4120), method 400 progresses to a stopping step 4130. Step 4130 changes the global flag for labelling audio windows to an unknown label. Changing the global flag effectively means that no audio window that is labelled with the unknown label will be used, and such audio windows are discarded. From step 4130 method 400 progresses to a synchronising step 4140. Step 4140 implements synchronisation by sending a G4 dwell instruction to ensure the 3D printer g-code cache is empty when the reply is received. Synchronising step 4140 may be performed using alternative methods as described for synchronising step 470. After completion of step 4140, method 400 progresses to a labelling step 4150. In step 4150 the global flag for labelling audio windows is set to non-depositing, meaning all audio windows from step 4150 onward will be labelled as non-depositing.

If at step 460, the g-code instruction read in step 450 was not a depositing instruction (“N” at step 460), the method 400 progresses under execution of the processor 205 to step 4150. From step 4150, the method 400 moves to a processing step 4160. The step 4160 processes the non-depositing instruction according to the method 700 of FIG. 7. From step 4160, method 400 loops back to the entry point of the main loop starting at decision step 440.

The main loop of the method 400 completes if all the g-code instructions in the file have been processed. A check occurs at two points in the main loop, at the step 440 and at the step 4100. If all g-code instructions have been processed in either decision steps 440 or 4100 (“N” at step 440 or step 4100), the method 400 progresses to a stopping step 4170. In step 4170 recording of audio is stopped. No audio windows are labelled or used after step 4170 in creation of classifier A. After execution of step 4170, the method 400 progresses under execution of the processor 205 to step 4180.

In execution of step 4180, the classifier A is trained. Training the classifier A uses the labelled spectral components (logarithms of the fast Fourier transform magnitudes) as the feature set for a logistic regression algorithm. Each audio window can have a label of either depositing or non-depositing, with any audio window labelled as unknown in the time during steps 4130 and 4140 before step 4150 being discarded. The method 400 exits by moving from step 4180 to step 4190, to return the newly created classifier A.

Referring to FIG. 5, the method 500 is now described. The method 500 is typically implemented as one or more modules of the software application 233, controlled by execution of the processor 205 and stored in the memory 206. The method 500 relates to determining occurrence of an error in implementing a g-code instruction.

The method 500 operates to create classifier B. The method 500 starts at a step, 520 in which audio recording is started and the recording received by the monitoring device 130. As described in relation to step 420 of the method 400, the step 520 entails starting a process which continuously and in parallel with the remainder of method 500 up to step S120, obtains audio windows, i.e. the logarithm of the frequency components determined at 200 ms intervals. The audio windows accordingly provide a spectral representation of the signal recorded by the vibration sensor 190. The audio windows are queued in a FIFO (first in first out) buffer to await classification by classifier A at step 595 to identify audio windows that correspond to depositing g-code instructions.

Following step 520, the method 500 enters a main loop at a step 530. An exit condition of the main loop of the method 500 is implemented at step 530. In summary, the main loop entails processing the complete g-code file with the exit condition, step 530, being that the complete g-code file has been processed. From decision step 530, if there are more g-code instructions to be processed (“Y” at step 530), the method 500 progresses under execution of the processor 205 to decision step 540. Decision step 540 checks whether the next g-code instruction is preceded by a depositing error marker in the g-code file.

A depositing error marker is a comment (using the standard g-code syntax of preceding a comment in a line with a semi-colon) in the g-code file, indicating that any g-code depositing instructions that follow in the g-code file after the comment are in some way disabled from depositing, either until the end of the file, or until a depositing success marker is encountered. Depositing may be disabled for example by a sequence of g-code instructions that set the nozzle to a temperature below the melting point of the material used, or partially or totally retracting the filament, or other methods as would be understood by a person skilled in the art. In either case, a depositing error marker signifies that a condition of non-depositing has been entered.

If at step 540 a depositing error marker is encountered preceding the current g-code instruction (“Y” at step 540), method 500 moves to step 550. In step 550, a depositing error flag, global to the method 500, is set. From step 550 the method 500 continues to a conditional step 560. If step 540 did not detect a depositing error marker (“N” at step 540), the method 500 directly progresses under execution of the processor 205 to a step 560.

Step 560 checks whether the current g-code instruction is preceded by a depositing success marker. As with the depositing error marker, the depositing success marker is a standard syntax g-code comment indicating that all depositing g-code instructions that follow are expected to be successful. For example, the comment could relate to “; Set Depositing Error Status” or “; Set Depositing Success Status”. If the decision step 560 detects the depositing success marker (“Y” at step 560), the method 500 moves under execution of the processor 205 to a setting step 570. In step 570 the method 500 sets a depositing success flag that is global to the method 500. The method 500 progresses under execution of the processor 205 from step 570 to a retrieving step 580. If the method 500 in step 560 did not detect an depositing success marker (“N” at step 560), the method 500 progresses directly to step 580.

At step 580, the method 500 retrieves the next g-code instruction. From step 580, the method 500 moves to a processing step 590. The step 590 executes the method 700 of FIG. 7 to send the g-code instruction to the 3D printer 1190. From step 590 the method 500 progresses under execution of the processor 205 to a classifying step 595. In step 595, all audio windows accumulated in the FIFO buffer are classified by classifier A as either representing sounds associated with depositing g-code instructions or non-depositing g-code instructions. Any audio windows classified to originate from sounds corresponding to non-depositing g-code instructions are discarded. The audio windows classified as being associated with depositing g-code instructions are labelled according to the global depositing success flag or the depositing error flag as set in either of the steps 550 and 570. From step 595, the method 500 moves under execution of the processor 205 to a decision step S100.

Step S100 is typically implemented based upon markers in g-code. If at step S100 no audio windows are classified as being associated with depositing instructions (“N” at step S100), the method 500 loops back from the decision step S100 to the beginning of the main loop at step 530. If one or more audio windows are classified as being associated with depositing instruction at step 595 (“Y” at step S100), the method 500 progresses from the decision step S100 to a labelling step S110.

In execution of the step S110, the method 500 marks all accumulated non-labelled audio-windows that were categorized as depositing instructions by classifier A in step 595. The accumulated non-labelled audio-windows that were categorized as depositing instructions are labelled according to the global depositing error or depositing success flag as set in either of steps 550 or 570. From step S110, the method 500 loops back to the entry point of the main loop at decision step 530.

If the method 500 determines at decision step 530 that there are no more g-code instructions to process in the g-code file (“N” at step 530), the method 500 progresses to a stopping step S120. In execution of step S120, the method 500 stops the audio recording process started at step 520. From step S120, the method 500 progresses to a training step 5130.

In execution of step 5130, the method 500 trains classifier B. Step 5130 effectively operates to use spectral analysis of the audio windows to determine that an error has occurred based upon predetermined criteria. The predetermined criteria can relate to spectral properties of the audio window such as weighting and the mapping of the signal type by the Classifier B. The training data for classifier B are the audio windows classified by classifier A as depositing instructions and labelled according to the global flag of either depositing error or depositing success. Importantly, the g-code file used for the method 500 is not an arbitrary g-code file representing any model. The g-code file used for the method 500 is carefully assembled with the correct makers (depositing error and depositing success) and the corresponding g-code sequences to ensure that extrusion either fails or succeeds. The g-code file used for the method 500 can in some implementations contain more than one physical model, with a print being restarted and including a process for clearing a print tray of the 3D printer 1190. Step 5130 determines features of the error that occurred in depositing layers of the structural material. The features of the error typically relate to spectral magnitudes of the vibration signal, multiplied by weights determined during training of the classifier B and/or spectral changes in the vibration signal (for example changing from positive to negative weighting). A strongly positive weight indicates a feature correlated with an error and a strongly negative weight indicates a feature that is not correlated with an error for example.

From step 5130, the method 500 proceeds to a step S140. At step S140 the method 500 completes by returning the created classifier B. For example, the classifier B can be stored in the memory 206.

A method 600 of FIG. 6 shows use of the arrangements described for monitoring a 3D printing process of the 3D printer 1190 for an error. If an error is detected, the monitoring device 130 (computer module 130) pauses the 3D printer 1190 and alerts a user of the additive manufacturing device 1190 in order for corrective action to be taken. By performing the method 500, errors can be detected at the time the errors occur. The method 600 is typically implemented as one or more modules of the software application 233, controlled by execution of the processor 205 and stored in the memory 206.

The method 600 starts with a decision step 620. The decision step 620 checks to see whether trained Classifier A and Classifier B exist, for example are stored in the memory 206. If the classifiers A and B do not exist (“N” at step 620), the method 600 progresses to a notification step 6100. In execution of the step 6100 the user is notified that monitoring cannot start due to the classifiers not existing. From step 6100 the method 600 proceeds to a decision step 6110. The decision step 6110 waits for user input, which will either abort the method 600, or instruct the method 600 to go execute a procedure to create the classifiers. If the user decides not to create the classifiers (“N” at step 6110), the method 600 progresses under execution of the processor 205 to an ending step 680. In the instance that the classifiers A and B do not exist, the step 680 in this case will do nothing as recording has not yet started and thereafter exit.

If the user decides to run through the procedure for creating the classifiers at step 6110, the method 600 moves under execution of the processor 205 from the decision step 6110 to a creating step 6120. In execution of the step 6120 the method 600 calls the method 300 to create the classifiers A and B. When the method 300 of creating the two classifiers has completed as previously described with reference to FIGS. 3, 4, and 5, the method 600 moves from step 6120 to recording step 630. If the decision step 620 determines that the classifiers A and B already existed when starting method 600, the method 600 proceeds directly to step 630.

At execution of step 630, the method 600 starts recording audio, producing 200 ms audio windows, each of which consists of the logarithmic magnitudes of frequency bins for the audio sample. The step 630 operates in a similar manner to the steps 420 and 520 of FIGS. 4 and 5 respectively. The monitoring device 130 operates to receive the vibration signal and produce the audio windows. From step 630, the method 600 moves to a setting step 631. The audio recording process of step 630 continues to run in parallel with the remainder of the method 600 up to the step 680. The audio windows are queued in a FIFO (first in first out) buffer to await classification by classifier A, and subsequently by classifier B, if identified by classifier A to correspond to depositing g-code instructions.

In execution of the step 631, the method 600 sets an error counter to 0. This error counter is used to determine a sequence of closely following audio-windows that are classified as firstly representing depositing g-code instructions by classifier A and secondly classified as depositing error by classifier B, as described below.

From step 631, the method 600 proceeds to a main loop to check for an exit condition at step 640. The main loop relates to steps from step 640. The exit condition for step 640 is a user decision to stop monitoring for a 3D print failure via a user interface input, for example a GUI executing on the computer module 130. If the monitoring device 130 is integrated within the printer 1190, the condition to stop monitoring is when the print being monitored has completed.

If the result of decision step 640 is to terminate monitoring (“Y” at step 640), the method 600 continues under execution of the processor 205 from decision step 640 to the step 680. In execution of step 680, recording audio is terminated if active and the method 600 ends. Any audio windows that were not classified and remain queued for classification are discarded.

If no indication is received to end monitoring in decision step 640 (“N” at step 640), the 3D printing process method 600 proceeds under execution of the processor 205 to a decision step 650. In execution of the decision step 650, the first available audio window is taken out of the FIFO buffer and passed to classifier A. If classifier A determines that the audio window does not correspond to a depositing g-code instruction (“N” at step 650), the method 600 does not further process that audio window and loops back to the beginning of the main loop of method 600 at step 640. In using the Classifier A, the step 650 effectively operates to map the signal received from the vibration sensor 190 to a class of g-code instruction for depositing a layer, based on the features of at least one of the audio window and the synthesizing instructions. The mapping at step 650 can relate to features of the vibration signal or a portion of the vibration signal (for example spectral properties), or properties associated with the corresponding instruction, for example timing and the type of synthesizing (g-code) instruction (such as extruding/non-extruding or heating/non-heating). The mapping identifies whether a portion of the vibration signal corresponds to deposition of the structural material.

If classifier A determines that the audio window that was removed from the FIFO buffer in step 650 does correspond to a depositing g-code instruction (“Y” at step 650), the method 600 moves to a decision step 660. In execution of the step 660, the method 600 uses the classifier B to determine whether the audio window removed from the FIFO buffer in step 650 corresponds to a depositing error or to a depositing success. After execution of step 660, the classified audio window is no longer required for further processing and is discarded. In using Classifier B, step 660 effectively operates to analyse spectral representation of the vibration signal based on the mapping at step 650 to determine if an error occurred in building the object. Determining the error is based upon predetermined criteria, including at least one of spectral properties of a portion of the vibration signal such as weighting, or other criteria such as a number of errors previously determined, and a time window in which previous errors were determined.

If, at step 660, the audio window is classified as a depositing success (“Y” at step 660), the method 600 moves under execution of the processor 205 to a decrementing step 663. Step 663 executes to decrease the error counter by one, with a floor value of zero. Decreasing the error counter by one and having a floor of zero serves to counteract classification errors by classifier B when an audio window is incorrectly classified as being a depositing error. Accordingly, the method 600 does not raise an alarm and pause the printing process because of a single audio window being classified as a depositing error. Rather, the printing process is only be paused if a series of audio windows are so classified, thereby effectively confirming the classification with higher confidence. From step 663, method 600 moves back to the beginning of the main loop at decision step 640.

If, at step 660, the audio window is classified as a depositing error (“N” at step 660), the method 600 moves under execution of the processor 205 to an incrementing step 661. In execution of step 661, the method 600 increments the error counter by one. From step 661, the method 600 proceeds to a decision step 662. In execution of step 662, the method 600 checks whether the error count has exceeded a previously set threshold. The threshold used at step 662 is determined by trial and error in some implementations. The threshold is determined based upon user requirements, such as cost of structural material, complexity of the object being synthesised, total printing time, and the like in other arrangements. The check at step 662 is used to determine whether a burst of audio windows were classified by classifier B as being depositing errors within a predetermined minimum period of time. An example threshold value which may be used is 10, resulting in a minimum time for failure classification of 2 seconds. If the threshold value has not been exceeded (“N” at step 662), the method 600 loops back from step 662 to the beginning of the main loop at step 631. If, however, the threshold has been exceeded in step 662 (“Y” at step 662), the method 600 proceeds under execution of the processor 205 to an action step 670.

If a threshold of 0 is used in step 662, the threshold effectively means that a single audio window classified as depositing error will cause warning action 670 to be taken. The threshold provides a smoothing functionality that effectively integrates the error and recognizes a sufficiently long burst of errors occurring within a short enough time. Alternative implementations only raise an error if a contiguous number of audio windows are classified as depositing error, that is by combining analysis of a plurality of contiguous portions of the received vibration signal. Implementations that raise an error if a contiguous number of audio windows are classified reset the error count to 0 in step 663, instead of decrementing by one towards zero. Steps 660 to 662 operate to determine the error based upon features of the vibration signal used to train the Classifier B at step 5130 of FIG. 5.

In execution of the step 670, the method 600 takes an appropriate action to pause the 3D printing process and to notify the user in order to resolve the situation. For example, the computer module 210 emits an alert noise or displays an alert message. Pausing the 3D printing process and notifying the user provides the clear benefit to the user of being able to address a print failure immediately after the failure occurs. From step 670, the method 600 moves under execution of the processor 205 to the step 680. In execution of the step 680, the audio recording is stopped and method 600 exits. Any audio windows that were not classified and remain queued up for classification are discarded. If the user wishes to restart monitoring, method 600 is restarted.

The method 700 shown in FIG. 7 shows processing of a g-code instruction by sending the instruction via the USB interface 120 to the 3D printer 1190. The method 700 is typically implemented as one or more modules of the software application 233, controlled by execution of the processor 205 and stored in the memory 206. The method 700 is implemented at steps 480 and 4160 of FIG. 4 and step 590 of FIG. 5.

The method 700 starts at a writing step 720. In execution of the step 720, the method 700 writes the g-code instruction, i.e. a non-empty and non-commented line in the g-code file to the USB interface 120 for the 3D printer 1190. From step 720, the method 700 moves under execution of the processor 205 to a waiting step 730. The processor 205 awaits a reply or acknowledgement from the additive manufacturing device 1190 received via the USB interface 120. G-code instructions are acknowledged typically by the string “ok”. Some commands expect extra information which will be read and returned in an appropriate structure. If an error “!!” or a resend “rs” string is received a fault is raised. Raising a fault raises an exception, aborting the method 700 and the calling methods up to a point that the exception is handled. From step 730, method 700 returns to the calling process (for example step 590 of the method 500).

The arrangements disclosed herein have been described in the context of detecting extrusion errors or failures where the additive manufacturing device 1190 is a fused filament fabrication device. The methods described also apply more broadly to detecting other types of errors in other additive or hybrid manufacturing devices. For example, the additive manufacturing device 1190 can be a laser or electron beam sintering 3D printer involving aiming a high energy beam at a bed of powdered metal. The metal is fused together where the beams strikes. When a layer is complete, the powder bed is lowered, and a fresh layer of powdered metal is swept over the top of the layer. Beam sintering devices may operate in a propagation medium such as regular atmosphere, a modified atmosphere, or a vacuum. In the case of operation in an atmosphere, the microphone 190 is mounted inside the enclosed build volume area 1140 and detects the operation of the device. In the case of a vacuum, the microphone 190 is typically replaced by a vibration sensor that is connected with the powder bed. In beam sintering devices, the relatively high energy of the beam imparts vibrations in the powder bed. The microphone 190 and the monitoring device 130 can therefore detect and learn the energy responses of normal and abnormal behaviour using processes analogous to the methods 400 and 500 of FIGS. 4 and 5 respectively. By applying the methods of FIGS. 4 and 5, heat source or energy beam failures can be detected, and the user alerted to the problem at the time the problem occurs according to the method 600 of FIG. 6.

The arrangements described can also be used with hybrid processes. Additive manufacturing devices which use hybrid processes iteratively mix steps of additive manufacturing processes followed by machining using subtractive manufacturing processes, as previously described. The arrangements described can be used for hybrid processes by using the approach of the methods described for FIGS. 3 to 7 for the additive manufacturing part of the hybrid process using the two classifiers A and B. However, in order to monitor the subtractive portion of the hybrid process the monitoring device 130 requires visibility of the g-code being processed. As described above, the monitoring device 130 can stay synchronized with the g-code commands being executed or alternatively directly be sending the g-code instructions to the controller 110. The monitoring device 130 tracks when cutting sounds are expected when the hybrid process switches to the subtractive part of the process. In order to know when cutting sounds are expected the monitoring device 130 keeps track of the volume that was deposited during the additive manufacturing part of the process, allowing the monitoring device 130 to determine when the head movement specified for the subtractive part of the process intersects the deposited volume and therefore is cutting material. The monitoring device 130 detects an error condition if no cutting sounds are detected when expected.

The description relating to FIG. 1 and FIG. 6 is based upon the additive manufacturing device 1190 being a separate device to the monitoring device 130. In the arrangement of FIGS. 1 and 6, the g-code is typically not available to the monitoring device at 640 onwards, unless the monitoring device is transmitting instructions to the 3D printer 1190 when implementing step 640 onwards. In an alternative arrangement the monitoring device 130 is not a separate device connected via the USB line 120, but a separate process within the central processing unit (CPU) controller 110, both when training the classifiers A and B and when monitoring operation of the 3D printer 1190. Using the architecture where the monitoring device 130 is not a separate device, classifier A, which detects audio windows corresponding to depositing instructions, is effectively no longer required. Classifier A is no longer required because a process performing the same task as separate device 130 has insight into the current g-code command being executed and therefore has complete knowledge whether a current audio-window, also captured within the same processor (controller 110) corresponds to what should be depositing actions. With this change the method 400 of FIG. 4, as implemented at step 320 of FIG. 3 (creating classifier A) is not required. Additionally, step 595 of the method 500 can be replaced with a step checking the current g-code being executed. Within the method 600, the step 650 can simply be replaced by a step that checks whether the current g-code being executed is a depositing instruction. The g-code instruction that is currently being executed is easily determined within the architecture where the monitoring device 130 is not a separate device. The g-code instruction that is currently being executed is easily determined as the execution is occurring within the same CPU in a different program thread, but provides full visibility. As described above, depositing g-code instructions for many typical 3D printers are the G0 (Rapid linear Move), G1 (Linear move), G2 (Controlled Arc Move—Clockwise) and G3 (Controlled Arc Move—Counter-Clockwise) instructions, representing depositing instructions if the E (length to extrude) field indicates a positive amount to be extruded.

Another alternative arrangement has the monitoring device 130 permanently connected via the USB interface 120 to the controller 110. In configuration where the monitoring device is permanently connected, the g-code file would be read for both training and normal printing operation by the monitoring device 130. The monitoring device 130 in some instances modifies the sequence g-code instructions sent to the controller by, for example, inserting the G4 command in order to flush the cache (as seen in steps 470 and 4160). In the configuration of permanently connecting the monitoring device 130 the classifier A would also not be essential, if synchronisation measures previously explained are followed.

An example of the use of the arrangements described is now provided based on FIG. 6. The intended application for the arrangements described is to monitor a 3D printer, and to detect when (and if) an error occurs. Upon detection of an error the user is notified and the print can be paused, depending on user configuration. Typically when using the arrangements described, the classifier A and the classifier B are already trained. Training typically only has to be done once for a new 3D printer setup. Accordingly, the program-flow follows the steps 620, 630 and 631 to enter the main loop at step 640.

In the main loop of the method 600, typical flow would follow steps 640, 650, 660, 663 and back to step 640. The typical flow follows the identified steps as most sounds during the 3D printing process correspond to depositing g-code instructions and 3D printers succeed far more often than not. Further, even a 3D print that fails is successful up to the point of failure at which point method 600 exits and would be restarted if the print is continued after addressing the identified error. The steps 660, 661 and 662 of the main loop may however also be taken relatively frequently in line with the classification error rates of both the classifier A and the classifier B. A warning action step 670 will only be taken if, over a period of time, more audio windows are classified as depositing errors than depositing successes (by classifier B in step 662) for audio windows that were first classified as depositing g-code instructions (by classifier A in step 650).

Therefore if for example the nozzle 185 of the 3D printer 1190 becomes clogged, or the printer 1190 runs out of filament 140 during the build, the path 640, 650, 660, 661 and 662 back to 640 will be repeatedly followed. Using for example a threshold of 10 and an audio window duration of 200 ms, the method 600 will trigger the warning action at step 670 in approximately 2 s. The exact length of time taken to implement the step 670 depends on the state of the error counter due to false classification before the error occurred and on the number of false classifications while the error is occurring. The nozzle 185 may not instantly stop extruding material completely when clogged, which makes a few incorrectly classified depositing successes by classifier B more likely.

If the arrangements described unexpectedly raise numerous false alarms, the user has the ability to explicitly retrain the classifier A and the classifier B. Such situations can occur if the environmental conditions in which the printer 1190 is used change. If, for example, some bearings of some moveable part in the printer become worn out, thereby changing the acoustic signature of some relevant aspects of operation, the outcome of the classification process is influenced. The new training data obtained during the classifier creation process can be either used in addition to previous training data or replace the previous training data. In some cases, use of new training data in addition to previous training data may help the training process to become more robust. In other cases using new training data can be preferable.

The arrangements described are applicable to the computer and data processing industries and particularly for the 3D printing industries.

The foregoing describes only some embodiments of the present invention, and modifications and/or changes can be made thereto without departing from the scope and spirit of the invention, the embodiments being illustrative and not restrictive.

1. A method for determining an error in building a three-dimensional object by an additive manufacturing device, the method comprising:
receiving a vibration signal, the vibration signal representing vibration of a propagation medium caused by the additive manufacturing device building the three-dimensional object by depositing layers of a structural material under control of a sequence of synthesizing instructions;
mapping a portion of the received vibration signal to at least one instruction from the sequence of synthesizing instructions to identify a portion of the received signal corresponding to deposition of the structural material, the mapping based on one or more features associated with the synthesizing instructions; and
analysing a spectral representation of the identified portion of the received signal based on at least one predetermined criterion to determine the error.

2. The method according to claim 1, further comprising training a classifier based upon vibration of the propagation medium during operation of the additive manufacturing device; and using the classifier to map the portion of the received signal to the at least one synthesising instruction.

3. The method according to claim 1, wherein the propagation medium relates to one of an atmosphere of a volume surrounding the additive manufacturing device or a frame of the additive manufacturing device.

4. The method according to claim 1, wherein analysing the spectral representation of the received vibration signal comprises determining a likelihood score by combining a plurality of frequency coefficients of the spectral representation, the plurality of frequency coefficients weighted in accordance with a set of weighting factors, wherein the weighting factors used to discriminate between a first set of frequencies associated with depositing of the structural material and a second set of frequencies associated with errors of depositing the structural material; and comparing the determined likelihood score with a predetermined threshold to detect the depositing error

5. The method according to claim 1, wherein determining the error comprises combining analysis of a plurality of contiguous portions of the received vibration signal.

6. A method of determining an error in synthesising a three-dimensional object by a manufacturing device, the method comprising:
receiving a vibration signal, the vibration signal recording vibration of a propagation medium caused by the manufacturing device synthesising the three-dimensional object under control of a sequence of synthesising instructions;
mapping a portion of the received signal to at least one instruction from the sequence of synthesising instructions, the mapping based on features associated with the synthesising instructions; and
analysing a spectral representation of the received signal based on the mapping to determine the error.

7. The method according to claim 6, wherein structural material deposition of the additive manufacturing device is a fused filament fabrication process, and the determined error relates to an extruding failure.

8. The method according to claim 6, wherein structural material deposition of the additive manufacturing device is a powder bed melting or sintering process, and the determined error relates to a heat source or energy beam failure.

9. The method according to claim 6, wherein the vibration signal is an acoustic signal.

10. A method of determining an error in depositing layers of a three-dimensional object by an additive manufacturing device, the method comprising:
operating the additive manufacturing device under control of a plurality of predetermined instructions;
receiving a vibration signal, the vibration signal recording vibration of a propagation medium caused by the additive manufacturing device operating under control of the plurality of predetermined instructions;
mapping a portion of the received vibration signal to at least one instruction from the plurality of predetermined instructions;
analysing a spectral representation of the received vibration signal based on the mapping to determine features of the error occurring in depositing layers of a structural material; and
determining occurrence of the error using the determined features.

11. The method according to claim 10, wherein mapping the portion of the received vibration signal comprises synchronising the received vibration signal with the synthesising instructions by the insertion of blocking non-synthesising instructions.

12. The method according to claim 10, wherein the predetermined instructions relate to one of depositing and non-depositing instructions and the mapping is used to train a classifier to identify depositing instructions.

13. The method according to claim 10, wherein mapping the portion of the received vibration signal comprises predicting a time taken by the synthesising instruction based on the synthesising instruction and a state of the additive manufacturing device.

14. The method according to claim 10, wherein mapping of the received signal to the at least one synthesising instruction is synchronised by detecting a layer transition of the additive manufacturing device.

15. An apparatus for determining an error in synthesising a three-dimensional object by an additive manufacturing device, the apparatus comprising:
a vibration sensor recording vibration of a propagation medium caused by the manufacturing device synthesising the three-dimensional object under control of a sequence of synthesising instructions;
a monitoring module coupled with the vibration sensor, the monitoring module being configured to map a portion of the recorded vibration signal to at least one instruction from the sequence of synthesising instructions, the mapping based on features associated with the synthesising instructions; and
a synthesising error detection module coupled with the vibration sensor and the monitoring module, the synthesising error detection module configured to analyse a spectral representation of the portion of the received signal based on the mapping to determine the error.

16. The apparatus according to claim 15, wherein the vibration sensor is attached to the additive manufacturing device to detect vibrations of the additive manufacturing device.

17. The apparatus according to claim 15, wherein the vibration sensor is a microphone

18. The apparatus according to claim 15, wherein the monitoring module is coupled with a controller of the additive manufacturing device, the monitoring module is configured to receive the sequence of synthesising instructions and analyse the sequence of synthesising instructions to map the portion of the recorded vibration signal to at least one instruction of the sequence of synthesising instructions based on features associated with the recorded vibration signal.

19. The apparatus according to claim 15, wherein the monitoring module is configured to modify the sequence of the synthesising instruction to map the portion of the recorded vibration signal to at least one instruction from the sequence of synthesising instructions.

20. A system, comprising:
an additive manufacturing device configured to build a three-dimensional object by depositing layers of a structural material under control of a sequence of synthesizing instructions;
a monitoring device, the monitoring device comprising
a vibration sensor configured to sense vibration of a propagation medium during operation of the additive manufacturing device,
a processor; and
a memory, the memory storing instructions executable on the processor to:
receive a vibration signal from the vibration sensor;
map a portion of the received vibration signal to at least one instruction from the sequence of synthesizing instructions to identify a portion of the received signal corresponding to deposition of the structural material, the mapping based on one or more features associated with the synthesizing instructions; and
analyse a spectral representation of the identified portion of the received signal based on at least one predetermined criterion to determine an error in building the three-dimensional object.

21. A computer readable medium having a program stored thereon for determining an error in building a three-dimensional object by an additive manufacturing device, the program comprising:
code for receiving a vibration signal, the vibration signal representing vibration of a propagation medium caused by the additive manufacturing device building the three-dimensional object by depositing layers of a structural material under control of a sequence of synthesizing instructions;
code for mapping a portion of the received vibration signal to at least one instruction from the sequence of synthesizing instructions to identify a portion of the received signal corresponding to deposition of the structural material, the mapping based on one or more features associated with the synthesizing instructions; and
code for analysing a spectral representation of the identified portion of the received signal based on at least one predetermined criterion to determine the error.
